(19) United States
(12) Patent Application Publication
(10) Pub. No.: US 2026/0023542 A1
(43) Pub. Date: Jan. 22, 2026

(54) SYSTEM AND METHOD FOR INTEGRATED COMPUTE KERNEL COMPILATION AND DEPLOYMENT

(71) Applicant: UNTETHER AI CORPORATION, Toronto (CA)

(72) Inventors: Bart Trojanowski, Ottawa (CA); Scott Kenneth Lindsay, Toronto (CA)

(21) Appl. No.: 18/774,577

(22) Filed: Jul. 16, 2024

(51) Int. Cl. G06F 8/41; G06F 8/30

(52) U.S. Cl. CPC G06F 8/425; G06F 8/311

(57) ABSTRACT

An example computing device includes: a memory storing a script comprising computer-executable instructions; a communications interface; a processor interconnected with the memory and the communications interface, the processor configured to: initiate execution of the script; and during the execution of the script: identify, within the script, a processing block to be executed on a target device; compile the processing block to machine code for execution on the target device; and deploy the machine code to the target device for execution.

### FIELD

The specification relates generally to compute kernel compilation, and more particularly to a system and method for integrated compute kernel compilation and deployment.

### BACKGROUND

During development processes, development of new software or new hardware requires many iterations of testing. Testing new code to run on hardware, or unit-testing portions of newly developed hardware involves deploying the new code to the hardware to be executed. However, prior to deploying the code, the code must be compiled into machine-readable instructions suitable for execution by the hardware. Testing may therefore be a time-consuming and resource intensive process, involving a first step of compiling the code for the target device, and then deploying the compiled code to the target device.

### SUMMARY

According to an aspect of the present specification an example computing device includes: a memory storing a script comprising computer-executable instructions; a communications interface; a processor interconnected with the memory and the communications interface, the processor configured to: initiate execution of the script; and during the execution of the script: identify, within the script, a processing block to be executed on a target device; compile the processing block to machine code for execution on the target device; and deploy the machine code to the target device for execution.

According to another aspect of the present specification, an example non-transitory machine-readable storage medium includes: a script of executable instructions which when executed by a processor of a host device cause the host device to: identify, within the script, a processing block to be executed on a target device; compile the processing block to machine code for execution on the target device; and deploy the machine code to the target device for execution.

According to another aspect of the present specification, an example method includes: initiating, at a host device, execution of a script comprising computer-executable instructions; during execution of the script: identifying, within the script, a processing block to be executed on a target device; compiling the processing block to machine code for execution on the target device; and deploying the machine code to the target device for execution.

### BRIEF DESCRIPTION OF DRAWINGS

Implementations are described with reference to the following figures, in which:

FIG. 1 depicts a block diagram of an example system for integrated kernel compilation and deployment.

FIG. 2 is a block diagram of an example target computing device for deployment of the compiled kernel.

FIG. 3 is a flowchart of an example method of integrated kernel compilation and deployment.

FIG. 4A is a schematic diagram of an example performance of blocks 315 to 330 of FIG. 3 with an affirmative determination at block 320.

FIG. 4B is a schematic diagram of an example performance of blocks 315 to 330 of FIG. 3 with a negative determination at block 320.

### DETAILED DESCRIPTION

In order to deploy functionality to a target device, two scripts or programs are typically written – one expressing the functionality to be executed by the target device, and one to steer the script for deployment to the target device. The independence of the scripts allows for ahead-of-time compilation of the functional script, however results in each script (i.e., each set of instructions) being stored and executed separately. Other systems may employ just-in-time (JIT) compilation, which allows compilation during execution of a program rather than before execution. However, such compilations are typically performed for dynamic programming languages and are performed for blocks being executed on the host machine.

Accordingly, as described herein, the present system allows for integrated compilation and deployment of processing blocks to a target computing device independent of the host device on which the script for integrated compilation and deployment is being executed. In particular, the script includes the processing block to be compiled and deployed to the independent target computing device. As part of execution of the script, the host (or compiling) computing device is configured to identify, compile and deploy the processing block to the target computing device.

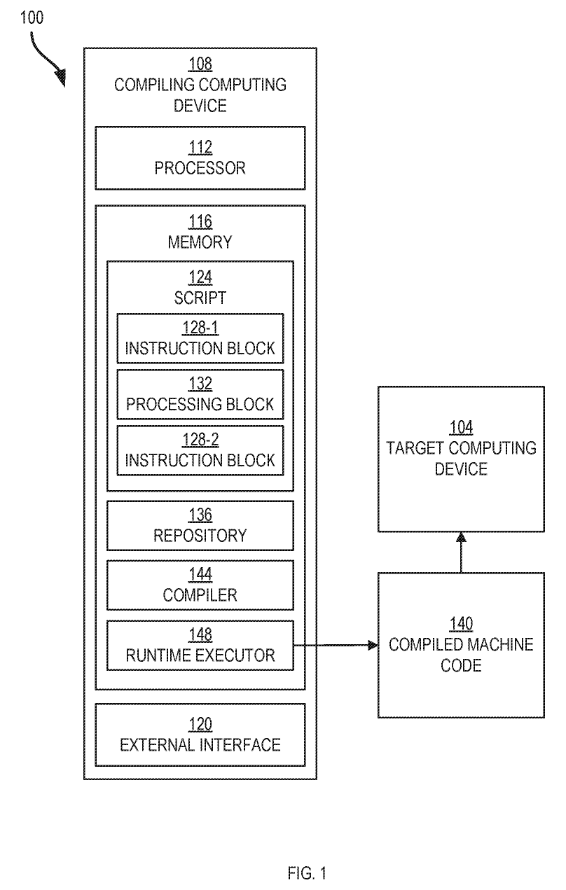

FIG. 1 depicts a system 100 for integrated compilation and deployment of processing blocks on a target computing device 104. In particular, the system 100 includes the target computing device 104, on which a processing block or kernel is to be deployed, and a compiling computing device 108 configured to compile and deploy the processing block or compute kernel in an integrated manner.

The target computing device 104 may have a spatial architecture and may be implemented with a configurable arrangement of processing elements and/or a closed set of such arrangements, which may be termed a “compute unit” in that a particular arrangement or closed set thereof performs a particular processing objective. This provides for flexibility in how a particular operation is performed. In particular, a compute unit may be configured to execute a processing block or kernel to achieve the particular processing operation. For example, the target computing device 104 may be deployed to implement operations for a neural network computation, artificial intelligence (AI) programs, large-language models (LLMs), machine vision programs, or similar.

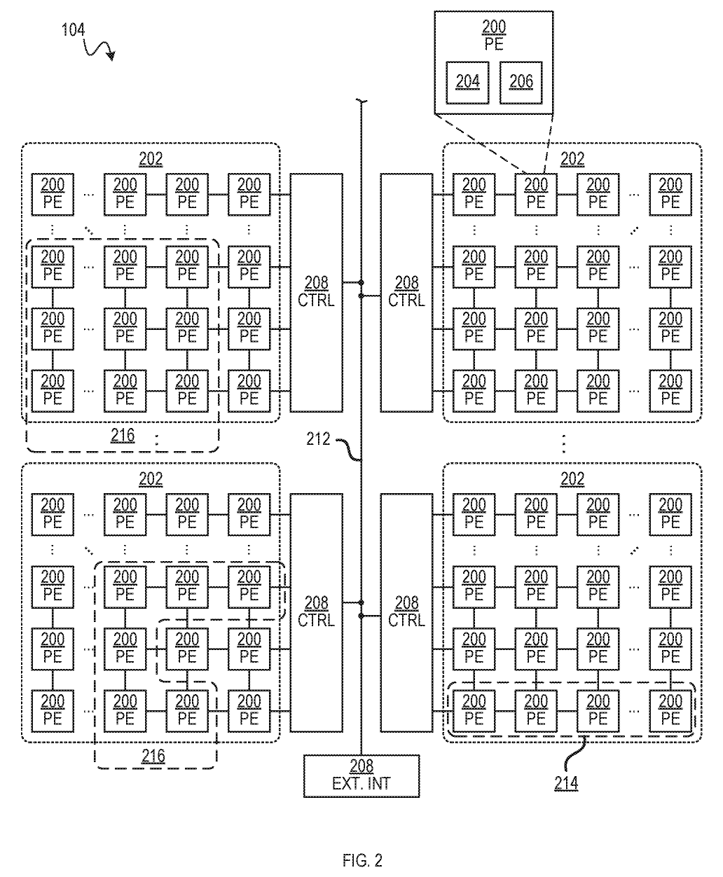

For example, referring to FIG. 2, an example target computing device 104 is depicted. At a low level, the computing device 104 operates according to SIMD principles, within a bank, row, or other grouping of processing elements, where such groupings may be referred to as compute units. At a high level, compute units communicate via a dataflow spatial architecture that is akin to a mesh network.

The computing device 104 includes an array of processing elements 200, in which subsets of the processing elements 200 may be configured to operate in SIMD fashion. The device 104 may include hundreds, thousands, or more processing elements 200.

The computing device 104 includes multiple banks 202 of processing elements 200. The bank 202 is a computing device, which may be termed a SIMD or at-memory computing device. US Patent No. 11,881,872, which is incorporated herein by reference, may be referenced for additional details concerning processing elements 200 and banks 202 thereof.

A bank 202 includes an array of processing elements or PEs 200. Processing elements 200 may be logically and, optionally, physically arranged in a two-dimensional array. Such an array may be considered to have rows and columns.

Each processing element 200 includes operational circuitry 204 to perform operations, such as multiplying accumulations. For example, each processing element 200 may include a multiplying accumulator and supporting circuitry. The processing element 200 may additionally or alternatively include an arithmetic logic unit (ALU) or similar processing or logic circuity to perform desired operations.

Each processing element 200 includes or is connected to working memory 206 (e.g., random-access memory or RAM) dedicated to that processing element 200.

A processing element 200 may be connected with one or more neighboring processing elements 200 to share data and instructions. Processing element interconnections may be provided in the row direction, the column direction, or both.

The computing device 104 further includes a controller 208 connected to the processing elements 200 of each bank 202. A controller 208 is a processor (e.g., microcontroller, etc.) that may be configured with instructions to control the connected processing elements 200. The controller 208 is dedicated to the processing elements 200 of the bank 202 it serves. The controller 208 may be considered part of the bank 202 or may be considered external to the bank 202.

The controller 208 controls the connected processing elements 200 to perform the same operation on different data contained in each processing element 200. The controller 208 may further control the loading/retrieving of data to/from the processing elements 200, control the communication among processing elements 200, and/or control other functions for the processing elements 200. Any suitable number of controllers 208 may be provided to control the processing elements 200. Controllers 208 may be connected to each other for mutual communications. Controllers 208 may be arranged in a hierarchy, in which, for example, a main controller controls sub-controllers, which in turn control subsets of processing elements 200.

The computing device 104 further includes a bus 212 to which the controllers 208 connect. The bus 212 allows the sharing of information among the controllers 208 and banks 202 and the sharing of programs and data with the configuring computing device 104, via an external interface 210 of the computing device 104. The external interface 210 may include a serial or parallel interface, such as a USB or PCIe interface.

The processing elements 200 may be configured as compute units that perform various tasks (i.e., kernels or processing blocks). Each compute unit may be controlled to operate in a SIMD fashion. Example compute units include a bank 202, multiple cooperating banks 202, a row (or column) 214 of processing elements 200, and an arbitrary group 216 of interconnected processing elements 200.

Returning to FIG. 1, the compiling computing device 108 includes a processor 112, a non-transitory machine-readable medium, such as a memory 116, and an interface 120. The processor 112 is interconnected with the memory 116 and the interface 120 to control the operations thereof.

The processor 112 may include a central processing unit (CPU), a field-programmable gate array (FPGA), an application-specific integrated circuit (ASIC), or similar processor. The processor 112 may be one processor or more than one processor configured for collective operation. The processor 112 cooperates with the memory 116 to realize the functionality described herein.

In particular, the memory 116 may include volatile working memory, such as a random-access memory (RAM) and/or an electronic, magnetic, optical, or other type of non-volatile physical storage device. Examples of such storage devices include a non-transitory computer-readable medium such as a hard drive (HD), solid-state drive (SSD), read-only memory (ROM), electrically-erasable programmable read-only memory (EEPROM), or flash memory. Some or all of the memory 116 may be integrated with the processor 112.

The memory 116 encodes or stores computer-executable instructions thereon, which when executed by the processor 112, enable or configure the device 104 to perform the functionality described herein. In particular, the memory 116 stores a script 124 comprising a series of computer-executable instructions. The script 124 enables integrated compilation and deployment of a processing block or kernel to the target device 104.

In particular, the script 124 includes a first instruction block 128-1, a target processing block 132, and a second instruction block 128-2 (referred to herein generically as an instruction block 128 or a block 128, and collectively as the instruction blocks 128 or the blocks 128; this nomenclature may also be used elsewhere herein). The first instruction block 128-1 may include pre-processing or configuration instructions for the processing block 132. For example, the instruction block 128-1 may identify configuration information for the subsequent deployment of the compiled processing block, such as a target set of banks 202 of processing elements 200, in the target computing device 104. In other examples, other configuration parameters or pre-compilation parameters may be specified by the instruction block 128-1. The instruction block 128-1 further implements a compiler to compile the processing block 132 to binary or machine code for execution by the target computing device 104.

The processing block 132 includes the instructions or kernel to be compiled to machine code 140 and executed on the target device 104. The second instruction block 128-2 may include deployment instructions for the processing block 132. That is, once the processing block 132 has been compiled to the machine code 140, the second instruction block 128-2 may include instructions for loading the machine code 140 to and running the machine code 140 on the target device 104.

Accordingly, the instruction blocks 128 may include computer-readable instructions executable on the compiling computing device 108 and hence may include instructions written in a higher-level programming language, such as Python, but in other examples may include instructions in lower-level programming languages, such as C++. The processing block 132 may include computer-readable instructions executable on the target computing device 104 and may include instructions written in lower-level programming languages, such as C++. That is, the first and second instruction blocks 128 may include instructions written in a first programming language, while the processing block 132 may include instructions written in a second programming language different than the instructions in the instruction blocks 128. In other examples, the instruction blocks 128 may also be written in lower-level programming languages, such as C++.

The memory 116 may further store a compiled kernel repository 136. The compiled kernel repository 136 is configured to store an association between identifiers for kernels or processing blocks which have already been previously compiled, and the associated resulting compilation (i.e., the binary or machine code representing the processing block). In particular, the compiled kernel repository may allow for compiled machine code for processing blocks which are used repeatedly to be stored and retrieved, rather than re-compiling the machine code from the processing block.

The memory 116 may additionally store a compiler 144 configured to compile instructions, such as those in the processing block 132, to machine code for execution, for example by the target computing device 104. The memory 116 may additionally store a runtime executor 148 configured to implement and deploy the processing block 132, and more particularly, the compiled machine code 140, to the target device 104.

The external interface 120 may be a serial or parallel communications interface, such as a Universal Serial Bus (USB) interface or Peripheral Component Interconnect Express (PCI-e) interface, that allows for communications to external devices, such as the target computing device 104.

In operation, the compiling computing device 108 may be configured for integrated compilation and deployment of the kernel or compute unit expressed by the processing block 132. In particular, compilation of the processing block 132 to generate the machine code 140 is performed in response to execution of instructions within the instruction block 128-1, while deployment of the compiled machine code 140 is performed in response to execution of instructions within the instruction block 128-2. Since the compilation and deployment are performed in response to execution of instructions within the same script 124, the compilation may also be referred to as just-in-time (JIT) compilation.

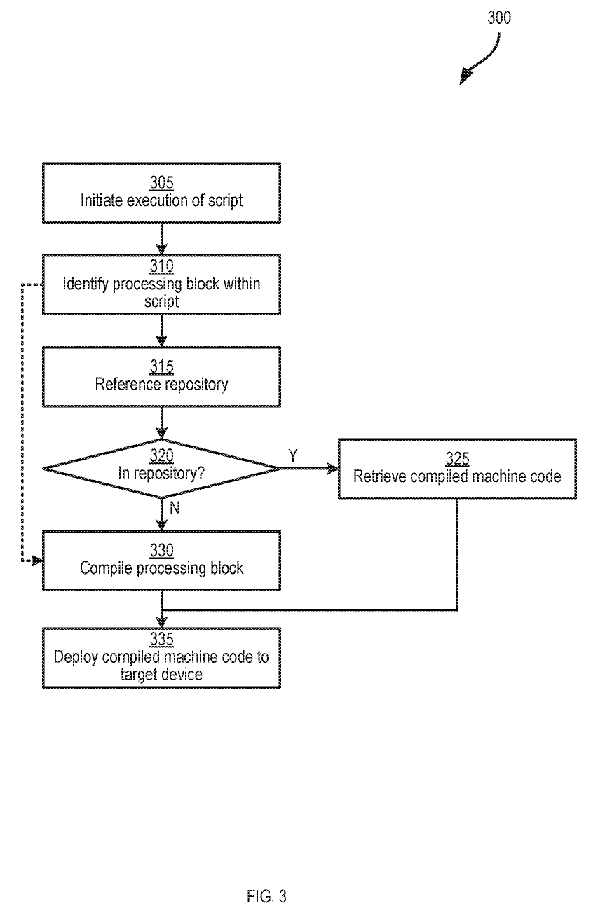

Turning now to FIG. 3, the functionality implemented by the device 108 will be discussed in greater detail. FIG. 3 illustrates a method 300 of compiling a kernel configuration, in particular with reference to the physical constraints of each compute kernel. The method 300 will be discussed in conjunction with its performance in the system 100, and particularly by the compiling computing device 108. In particular, the method 300 will be described with reference to the components of FIGS. 1 and 2. In other examples, the method 300 may be performed by other suitable devices or systems.

At block 305, the compiling computing device 108 is configured to initiate execution of the script 124, for example in response to an initiation condition. For example, the initiation condition may be a trigger or command from an operator of the compiling computing device 108. In particular, the compiling computing device 108 may execute the first instruction block 128-1. In response to executing the first instruction block 128-1, the compiling computing device 108 may identify and/or define the configuration parameters for the subsequent deployment of the processing block 132 to the target computing device 104. For example, the compiling computing device 108 may identify a target compute unit within the target computing device 104 or the like.

At block 310, in response to execution of the script 124, the compiling computing device 108 is configured to identify the processing block 132 within the script 124 for compilation. For example, the first instruction block 128-1 may additionally include compilation instructions to configure the compiling computing device 108 to examine the remainder of the script 124 to identify and extract the processing block 132. The processing block 132 may be identified by certain delimiters (e.g., special characters or sequences thereof), predefined variables (e.g., as identified by a certain predefined variable name, such as “CODE”, or similar), combinations of the above, and the like. The processing block 132 may then be sent the runtime executor 148 for deployment and execution on the target device 104. That is, the script 124 may invoke the runtime executor 148 to act on the processing block 132. In other examples, some or all of the blocks described below may be performed by other components, for example via integration with the compiler 144 or the like.

At block 315, the compiling computing device 108, and in particular the runtime executor 148, may determine an identifier for the processing block 132 identified at block 310 and reference the repository 136. In particular, the identifier may be a deterministic value, as determined by the processing block 132. For example, the identifier may be a hash value of the processing block 132, using any suitable hashing scheme or function. Accordingly, the compiling computing device 108 may be configured to determine a hash value of the processing block 132 and compare the hash value to the repository 136.

At block 320, if the compiling computing device 108 determines that the hash value is in the repository, then the device 108 proceeds to block 325. At block 325, the compiling computing device 108 is configured to retrieve the compiled machine code 140 corresponding to the hash value, and therefore to the processing block 132, from the repository 136. That is, the runtime compiler 148 may return the machine code 140 retrieved from the repository 136. The compiling computing device 108 may then proceed to block 335.

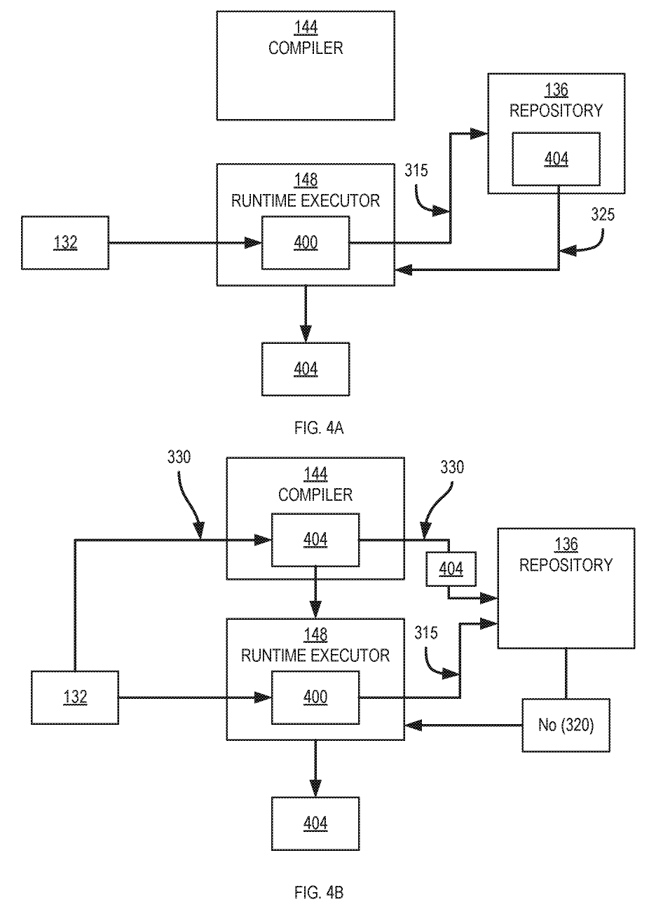

For example, referring to FIG. 4A, a schematic diagram illustrating an example performance of blocks 315 to 325 is depicted, with an affirmative determination at block 320. At block 315, in response to receiving the processing block 132, the runtime executor 148 may apply a hash function to the processing block 132 to obtain a hash value 400. The runtime executor 148 may then reference the hash value 400 against the identifiers in the repository 136. That is, the hash value 400 may be the identifier for the compiled machine code stored in the repository 136. Accordingly, if the runtime executor 148 determines that the hash value 400 is present in the repository 136, then at block 325 the runtime executor 148 may retrieve from the repository 136, the corresponding compiled binary and/or machine code 404 stored in association with the hash value 400.

In particular, by referencing the repository 136, the runtime executor 148 may leverage previously compiled and stored machine code to further expedite the just-in-time compilation of the processing block 132.

Returning to FIG. 3, if, at block 320, the determination is negative, that is, the hash value for the processing block 132 identified at block 310 is not in the repository 136, then the device 108 proceeds to block 330. At block 330, the compiling computing device 108 is configured to compile the processing block 132 to generate the corresponding machine code 140. For example, the runtime executor 148 may invoke the compiler 144 to compile the processing block 132. In some examples, the compiling computing device 108 may proceed directly to block 330 after identifying the processing block 132 within the script 124 at block 310. That is, the compiling computing device 108 may compile the respective processing block 132 at each iteration of the method 300, rather than referencing the repository 136 to retrieve previously compiled machine code. In examples in which the compiling computing device 108 leverages stored machine code in the repository 136, the device 108 may additionally store the compiled machine code 140 generated at block 330 in association with the identifier for the processing block 132 in the repository 136.

For example, referring to FIG. 4B, a schematic diagram illustrating an example performance of blocks 315, 320, and 330 is depicted, with a negative determination at block 320. In particular, the runtime executor 148 applies the hash function to the processing block 132 to obtain the hash value 400. The runtime executor 148 may then, at block 315, reference the hash value 400 against the identifiers in the repository 136. Since the repository 136 stores identifiers or hash values for which a previous compilation has been made, if, at block 320, the runtime executor 148 determines that the hash value 400 is not present in the repository 136, then the runtime executor 148 may conclude that compiled machine code for the processing block 132 is not available (i.e., a negative determination is made at block 330. Accordingly, at block 330, the runtime executor 148 is configured to invoke the compiler 144 to compile the processing block 132 to generate the machine code 404. Additionally at block 330, the compiled machine code 404 may then be stored in the repository 136 in association with the hash value 400. The compiler 144 may also return the compiled machine code 404 to the runtime executor 148 for further processing.

Returning again to FIG. 3, at block 335, after obtaining the compiled machine code 140 from the compiler 144, either by compiling the processing block 132 or by retrieving the machine code 140 from the repository 136, the compiling computing device 108 is configured to deploy the compiled machine code 140 to the target device 104. In particular, block 335 may be performed as a result of execution of the second instruction block 128-2. For example, the second instruction block 128-2 may configure the compiling computing device 108 to load the compiled machine code 140 according to the configuration parameters defined in the first instruction block 128-1. The second instruction block 128-2 may further configure the compiling computing device 108 to trigger or cause the target computing device 104 to run the compiled machine code 140.

That is, one or both of the first and second instruction blocks 128 may cooperate with the runtime executor 148 to prepare and deploy the processing block 132 to the target device 104. For example, the first instruction block 128-1 may prepare or prime or configure the runtime executor 148 and the processing block 132 with the compiled machine code 140, while the second instruction block 128-2 may cause the runtime executor 148 to deploy the compiled machine code 140.

In some examples, the second instruction block 128-2 may further configure the compiling computing device 108 to monitor or track the execution of the compiled machine code 140 by the target computing device 104. For example, the compiling computing device 108 may record performance metrics, including run time, latency, errors and/or other results of the processing block 132, and the like.

As described above, the present system 100 may be deployed, for example as a testing system to efficiently test a new target computing device 104 and/or new functionality developed for operations on the target computing device 104.

For example, the processing block 132 defined within the script 124 may include unit tests for testing one or more components (e.g., different compute units) of the target computing device 104. In such examples, the instruction blocks 128-1 and 128-2 may act as steering instructions configured to select the appropriate components or compute units of the target computing device 104, as well as to extract performance metrics during execution of the compiled machine code 140 by the target computing device 104.

In other examples, the processing block 132 may define instructions enabling new functionality, or a portion of a new software or the like. Integration of the processing block 132 into the script 124 may thereby allow developers to make incremental changes to the processing block 132 without separately needing to save or store, compile and deploy each version.

Thus, as described herein, the presently described system allows for integrated compilation and deployment of a processing block or kernel. In particular, the system employes just-in-time compilation to allow a computing device to initiation execution of a script, and during execution of the script (and in fact in response to execution of the script), identify a processing block within the script to be JIT compiled. The JIT compiled kernel may then, also during execution of the script (and in fact in response to execution of the script), be deployed to the target computing device for execution on the target computing device.

The scope of the claims should not be limited by the embodiments set forth in the above examples but should be given the broadest interpretation consistent with the description as a whole.

1. A computing device comprising:
a memory storing a script comprising computer-executable instructions;
a communications interface;
a processor interconnected with the memory and the communications interface, the processor configured to:
initiate execution of the script; and
during the execution of the script:
identify, within the script, a processing block to be executed on a target device;
compile the processing block to machine code for execution on the target device; and
deploy the machine code to the target device for execution.

2. The computing device of claim 1, wherein the processor is configured to, during execution of the script:
define configuration parameters for the target device; and
deploy the machine code to the target device according to the configuration parameters.

3. The computing device of claim 1, wherein, to compile the processing block to the machine code, the processor is configured to:
apply a hash function to the processing block to obtain a hash value;
reference the hash value to a compiled kernel repository stored in the memory; and
when the hash value is in the repository, retrieve the machine code from the repository.

4. The computing device of claim 3, wherein the processor is further configured to:
when the hash value is not in the repository, compile the processing block to the machine code; and
store the hash value in association with the machine code in the repository.

5. The computing device of claim 1, wherein, to deploy the machine code, the processor is configured to:
load the machine code to the target device; and
cause the target device to execute the machine code.

6. The computing device of claim 1, wherein the processing block comprises a unit test for a target compute unit of the target computing device.

7. The computing device of claim 6, wherein the processor is further configured to obtain performance metrics for the target compute unit during execution of the unit test on the target device.

8. A non-transitory machine-readable storage medium comprising a script of executable instructions which when executed by a processor of a host device cause the host device to:
identify, within the script, a processing block to be executed on a target device;
compile the processing block to machine code for execution on the target device; and
deploy the machine code to the target device for execution.

9. The non-transitory machine-readable storage medium of claim 8, wherein the script comprises:
a first instruction block, which when executed causes the host device to define configuration parameters for the target device; and
a second instruction block, which when executed causes the host device to deploy the machine code to the target device according to the configuration parameters.

10. The non-transitory machine-readable storage medium of claim 9, wherein the first instruction block and the second instruction block comprise instructions in a first programming language, and the processing block comprises instructions in a second programming language.

11. The non-transitory machine-readable storage medium of claim 9, wherein the processing block comprises a unit test for a target compute unit of the target device.

12. The non-transitory machine-readable storage medium of claim 11, wherein the second instruction block comprises instructions which when executed causes the host device to obtain performance metrics for the target compute unit during execution of the unit test on the target device.

13. The non-transitory machine-readable storage medium of claim 8, further comprising a compiler comprising computer-executable instructions which when executed cause the host device to compile the processing block to the machine code, wherein the compiler is invoked by the script to act on the processing block to compile the machine code.

14. The non-transitory machine-readable storage medium of claim 13, wherein execution of the compiler configures the host device to:
apply a hash function to the processing block to obtain a hash value;
reference the hash value to a compiled kernel repository;
when the hash value is in the repository, retrieve the machine code from the repository; and
when the hash value is not in the repository:
compile the processing block to the machine code; and
store the hash value in association with the machine code in the repository.

15. A method comprising:
initiating, at a host device, execution of a script comprising computer-executable instructions;
during execution of the script:
identifying, within the script, a processing block to be executed on a target device;
compiling the processing block to machine code for execution on the target device; and
deploying the machine code to the target device for execution.

16. The method of claim 15, wherein execution of the script further comprises:
defining configuration parameters for the target device; and
deploying the machine code to the target device according to the configuration parameters.

17. The method of claim 15, wherein compiling the processing block comprises:
apply a hash function to the processing block to obtain a hash value;
reference the hash value to a compiled kernel repository; and
when the hash value is in the repository, retrieve the machine code from the repository.

18. The method of claim 17, further comprising: when the hash value is not in the repository:
compile the processing block to the machine code; and
store the hash value in association with the machine code in the repository.

19. The method of claim 15, wherein the processing block comprises a unit test for a target compute unit of the target computing device.

20. The method of claim 19, further comprising obtaining performance metrics for the target compute unit during execution of the unit test on the target device.
